(19) United States
(12) Patent Application Publication
(10) Pub. No.: US 2026/0133408 A1
(43) Pub. Date: May 14, 2026

(54) IMAGING LENS, ASSOCIATED CAMERA, AND IMAGING SYSTEM

(71) Applicant: INSTITUT NATIONAL D'OPTIQUE, Québec (CA)

(72) Inventor: Min WANG, Québec (CA)

(21) Appl. No.: 19/119,438

(22) PCT Filed: Nov. 4, 2022
(86) PCT No.: PCT/CA2022/051629

§ 371 Date: Apr. 9, 2025

(51) Int. Cl. G02B 13/00; G02B 1/11; G02B 3/00; G03B 19/22; G03B 35/08; H04N 23/55; H04N 23/58

(52) U.S. Cl. CPC G02B 13/005; G03B 19/22; G03B 35/08; H04N 23/55; G02B 1/11; G02B 2003/0093; H04N 23/58

(57) ABSTRACT

Imaging systems integrating a plurality of cameras with different fields of view to enable a step-zoom feature are described. Each camera includes an imaging lens provided in monolithic form. The imaging lens can have a monolithic body made of a single piece of optical material, the monolithic body having: an entrance optical surface configured for receiving light incident thereon, this surface being spherically curved with a convex curvature: an exit optical surface configured for direct coupling to a spherically-curved image sensor array, the exit optical surface being spherically curved with a convex curvature; and a lateral surface extending from a periphery of the entrance optical surface to a periphery of the exit optical surface, the lateral surface being shaped to have a minimum sectional diameter. The minimum sectional diameter defines an aperture stop that is conjugate to the entrance pupil of the imaging lens.

### FIELD

The specification relates to imaging systems, and describes an example imaging system integrating a plurality of cameras having fields of view of different sizes to enable a step-zoom feature, and wherein each camera comprises an imaging lens provided in a monolithic form.

### BACKGROUND

Various types of imaging systems have been developed over the last decades, many of which being specifically adapted to applications that require operation within a specific waveband of the electromagnetic spectrum (e.g. visible, ultraviolet, infrared or microwave). While such systems have been satisfactory to a certain extent, there always remains room for improvement. In the case of imaging systems designed for operation with infrared light, there remains a need for improvements according to various requirements relating to compactness, manufacturing cost, optical resolution, field of view (FOV), control of the optical aberrations, and the level of illumination of the image sensor array via designs of the imaging lens train (objective lens) with low f-numbers.

### SUMMARY

In accordance with one aspect, there is provided an imaging lens, the imaging lens having a lens axis and comprising: a monolithic body made of an optical material, the monolithic body having: an entrance optical surface configured for receiving light incident thereon, the entrance optical surface being spherically curved with a convex curvature and an entrance center of curvature located on the lens axis; an exit optical surface configured for direct coupling to a spherically-curved image sensor array, the exit optical surface being spherically curved with a convex curvature and an exit center of curvature located on the lens axis; and a lateral surface extending from a periphery of the entrance optical surface to a periphery of the exit optical surface, the lateral surface being shaped such that the monolithic body has a minimum sectional diameter, the minimum sectional diameter and the entrance center of curvature being located in a same plane, the minimum sectional diameter defining an aperture stop centered on the lens axis and conjugate to an entrance pupil of the imaging lens; wherein the imaging lens has a focal surface that is spherically curved with a focal curvature corresponding to the convex curvature of the exit optical surface, the focal surface being coincident with the exit optical surface.

In accordance with another aspect, there is provided a camera comprising: the imaging lens; the image sensor array being spherically curved and having a two-dimensional array of photosensitive elements, said image sensor array having a sensor curvature adapted for direct optical coupling to the exit optical surface, said image sensor array being operable to generate electrical output signals indicative of a light irradiance distribution formed at the exit optical surface; and an electronic printed-circuit board operable to control the image sensor array and to generate output image data.

In accordance with another aspect there is provided an imaging system comprising: a plurality of the cameras, a support structure receiving each camera of the plurality of cameras, the plurality of cameras having a common boresight alignment with the lens axes of the imaging lenses of the plurality of cameras being parallel and spaced apart from one another; a display screen; a user interface; and an image processor operable to receive and process the image data from the plurality of cameras and to display images on the display screen.

Many further features and combinations thereof concerning the present improvements will appear to those skilled in the art following a reading of the instant disclosure.

### DESCRIPTION OF THE FIGURES

In the figures,

FIG. 1 is a schematic side elevation view of an example of a camera having an imaging lens in accordance with an example embodiment;

FIG. 2 is a schematic side elevation view of another example embodiment of an imaging lens which can form part of a camera such as shown in FIG. 1, with FIGS. 2A and 2B being cross-sectional views taken along lines 2A-2A and 2B-2B of FIG. 2, respectively;

FIG. 3 is a schematic side elevation view of yet another example embodiment of an imaging lens which can form part of a camera such as shown in FIG. 1, with FIGS. 3A and 3B being two different oblique views of an example encasing structure, and FIGS. 3C and 3D showing the two halves of the example encasing structure, respectively;

FIG. 4 is a schematic view of an imaging system in accordance with an embodiment;

FIG. 5 displays the computed polychromatic modulation transfer functions (MTFs) for different zoom configurations and the relative illumination as a function of the angular position for an imaging system such as the one illustrated in FIG. 4, in accordance with a first embodiment for operation in the MWIR waveband;

FIG. 6 provides output image simulations for the embodiment of the imaging system whose MTFs are illustrated in FIG. 5: (a) Original input scene image with a diagonal full FOV of 120°; (b) Image simulated for the zoom configuration with f₁=3.26 mm; (c) Image simulated for the zoom configuration with f₂=6.52 mm. The diagonal FOV is 56° for this simulated image; (d) Image simulated for the zoom configuration with f₃=10.03 mm;

FIG. 7 displays the computed polychromatic MTFs for different zoom configurations and the relative illumination as a function of the angular position for an imaging system such as the one illustrated in FIG. 4, in accordance with a second embodiment for operation in the visible waveband;

FIG. 8 provides output image simulations for the embodiment of the imaging system whose MTFs are illustrated in FIG. 7: (a) Original input scene image with a diagonal full FOV of 120°; Images simulated for the zoom configurations with (b) f₁=4.0 mm; (c) f₂=8.0 mm; and (d) f₃=16.0 mm.

### DETAILED DESCRIPTION

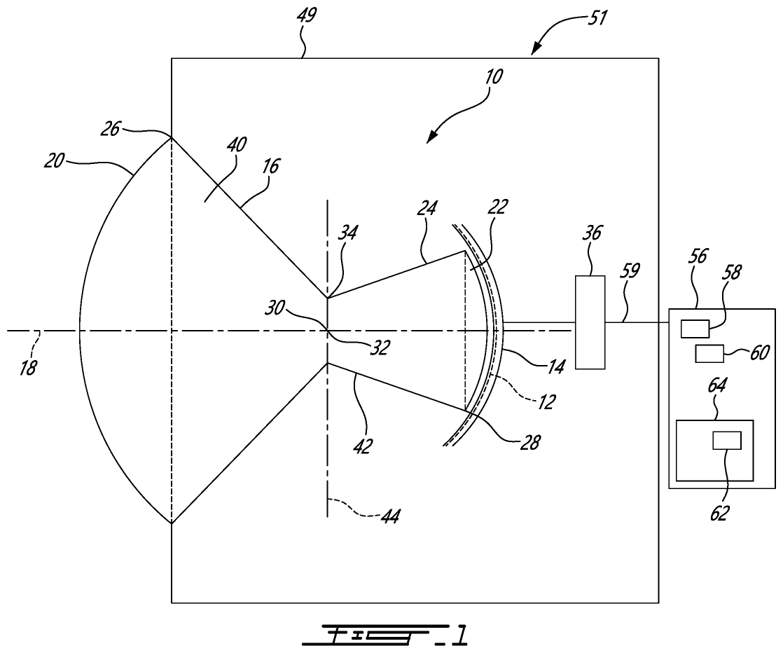

FIG. 1 shows an example of a camera 51 that comprises an imaging lens 10 (also referred to in the art as an objective lens, or simply an objective) in accordance with one embodiment. Generally, the imaging lens 10 can have a spherically-curved focal surface 12, as explained in further details below.

In this example, the imaging lens 10 has a monolithic body 16 made of a single piece of a suitable optical material. The monolithic body 16 generally has a lens axis 18 (also denoted as an optical axis), an entrance optical surface 20, an exit optical surface 22, and a lateral surface 24. Light coming from the scene to be imaged propagates from left to right in the figure. Each one of the entrance 20 and exit 22 optical surfaces has its vertex located on the lens axis 18. The lateral surface 24 of the monolithic body 16 extends continuously from the periphery of the entrance optical surface 20 to the periphery of the exit optical surface 22 and it circumscribes the monolithic body 16 around the lens axis 18. As suggested above, the wording “monolithic” used herein implies that the body 16 is made of a single piece of optical material. As compared to its more conventional multi-element counterparts, the imaging lens 10 described herein may offer attractive benefits such as generally requiring fewer manufacturing steps for the fabrication of the lens and much easier alignment and positioning procedures, which can impact heavily on the procurement costs of such lenses.

As depicted in FIG. 1, the entrance optical surface 20 is spherically curved with a convex curvature. The entrance optical surface 20 has an entrance center of curvature 30 located on the lens axis 18. The entrance optical surface 20 is configured for receiving light incident thereon, the light coming from a distant scene (not shown in FIG. 1) to be imaged. Likewise, the exit optical surface 22 of the monolithic body 16 is spherically curved with a convex curvature, and it has an exit center of curvature 32 located on the lens axis 18. The exit center of curvature 32 can coincide with the entrance center of curvature 30, as illustrated in the embodiment shown in FIG. 1. In an embodiment of the imaging lens 10, the values of the main design parameters such as the radii of curvature of the entrance 20 and exit 22 optical surfaces, the distance between the vertices of these optical surfaces and the refractive index of the optical material of the monolithic body 16 are selected in view of obtaining a spherically-curved focal surface 12 coincident with the exit optical surface 22 and having a curvature nearly the same as that of the exit optical surface 22. As a result, a spherically-curved image sensor array 14 in contact with or placed in close proximity to the exit optical surface 22 will have its photosensitive surface area coinciding with the focal surface 12 of the imaging lens 10. Images of remote scenes formed on the focal surface 12 can then be brought into focus on the photosensitive area of the image sensor array 14.

The term “coincident with” used throughout this description should be construed as meaning that a first element, either real or virtual, is located at the same place that a second element, but within tolerances that are considered acceptable for the proper operation of the exemplary embodiment.

The lateral surface 24 is shaped so that the monolithic body 16 has a minimum sectional diameter 34 located at a specific axial position along the lens axis 18. The minimum sectional diameter 34 can be referred to as the “waist” of the monolithic body 16. The minimum sectional diameter 34 defines an aperture stop for the imaging lens 10, and it is preferably centered on the lens axis 18. In this specification, the expressions “minimum sectional diameter” and “aperture stop” will be used interchangeably, with the same reference numeral 34. The aperture stop 34 is located at an axial position that coincides with that of the center of curvature of the entrance optical surface 20. This means that the entrance pupil of the imaging lens 10 is conjugate to the aperture stop, namely it is the image of the aperture stop 34 formed by the part of the imaging lens 10 that is located in front of the aperture stop 34. In addition, the entrance pupil (not depicted in FIG. 1) is located at the same axial position as the aperture stop 34 while its diameter exceeds that of the aperture stop by a factor given by the refractive index of the optical material forming the monolithic body 16. The diameter of the aperture stop 34 can then be selected to obtain an imaging lens 10 with a desired f-number. This embodiment can then be free of off-axis aberrations, such as coma and astigmatism. The exit optical surface 22 can be adapted to provide a residual field curvature in such a way that the image of the viewed scene is formed just outside of the exit optical surface 22, on a sphere concentric with the spherical curvature of this surface 22. As a result, the spherically-curved image sensor array 14 can be located on the curved focal surface 12 of the imaging lens 10.

The configuration of the imaging lens 10 depicted in FIG. 1 can provide attractive features such as greater compactness, reduced overall manufacturing costs, a higher optical resolution, a wider field of view and a control of optical aberrations via a design offering a relatively low f-number for better illumination of the image sensor array 14. Indeed, the conventional alternative approach consisting in manufacturing separate lens elements and then mounting them to form a multi-element objective lens train may reveal as more complex and costly, considering the fabrication of the various optical and opto-mechanical elements within the required dimensional tolerances and then assembling them within the specified centering and positioning tolerances. As a result, an imaging lens 10 comprising a single monolithic body, as disclosed in this specification, may provide an attractive counterpart to the conventional approaches.

Providing the imaging lens 10 as a monolithic body 16 may benefit from the presence of a progressively decreasing cross-sectional area of the monolithic body 16 along the orientation of the lens axis 18, in the vicinity of the plane of the minimum sectional diameter 34. FIG. 1 depicts a particularly simple embodiment of the imaging lens 10 in which the lateral surface 24 of the monolithic body 16 comprises two truncated conical portions sharing a same axis of symmetry (i.e., the lens axis 18) and that connect at the axial position of the minimum sectional diameter 34. Hence, a first truncated conical portion 40 of the monolithic body 16 can extend from the periphery 26 of the entrance optical surface 20 to the plane 44 of the minimum sectional diameter 34 while a second truncated conical portion 42 can extend from the plane 44 of the minimum section diameter 34 to the periphery of the exit optical surface 22. For both conical portions 40 and 42, the cross-sectional area of the monolithic body 16 can decrease continuously when moving towards the plane 44 of the minimum sectional diameter 34. However, many other variants are possible. An imaging lens 10 having a monolithic body shaped as illustrated in FIG. 1 can provide satisfactory optical corrections for operation in the midwave infrared (MWIR-wavelengths ranging from about 3 to 5 μm) and long-wave infrared (LWIR) wavebands, including corrections of monochromatic and chromatic aberrations.

The lateral surface 24 of the monolithic body 16 can be covered with an opaque material (not shown in FIG. 1) such as a suitable optically-absorbing black paint in order to block stray light. In other embodiments, it may alternately or additionally be preferred to enclose the monolithic body 16 in a casing made of an opaque material, the casing directly abutting the lateral surface 24. In some embodiments, opto-mechanical baffles may alternately or additionally be placed close to the portion of the lateral surface 24 that surrounds the minimum sectional diameter 34.

The optical material of the monolithic body 16 can be selected by a skilled designer taking into consideration factors such as the intended operation waveband, the optical transmission of the material in that waveband, the affordability of the material and its ability to sustain the environmental conditions to which the imaging lens 10 can be submitted. As one potential example, infrared (IR) optical materials such as germanium, zinc selenide or molded chalcogenide glass (e.g. Gasir1) can be used for the monolithic body 16 if operation in the IR spectral wavebands, and more specifically spectral wavebands spanning from 3 to 12 μm or from 3 to 14 μm is intended. As another potential example, the monolithic body 16 can be made of an optical glass or of a polymer material having optical properties suitable for operation in the visible spectral waveband. In some embodiments, the entrance 20 and/or the exit 22 optical surface of the monolithic body 16 can be provided with an antireflective (AR) coating to lower the reflection losses at these interfaces.

Some applications of the imaging lens 10 may call for restricting the extent of its operation waveband. In this purpose, thin films acting as a bandpass optical filter can be deposited on the entrance optical surface (20), on the exit optical surface (22), or on both optical surfaces. In an alternate embodiment, a spherically-curved window acting as a bandpass optical filter can be mounted on the entrance optical surface 20.

In example embodiments intended for operation in an IR waveband such as the MWIR or the LWIR, the working focal ratio (f-number) of the imaging lens 10 may need to be as low as possible, down to F/1 or even lower when it is optically coupled to a microbolometer image sensor array. The expression focal plane array (FPA) is often used to refer to (planar) image sensor arrays such as arrays of microbolometers, and this expression will also be used in this specification to designate spherically-curved (i.e., non planar) image sensor arrays. To make the imaging lens 10 anastigmatic or quasi-anastigmatic, IR optical materials having high refractive indices n, for instance n>2.3, can be used to reduce spherical aberrations in devices with fast optics (low f-number). The high-refractive-index material combines with the aperture stop 34 located in the plane 44 containing the center of curvature 30 of the entrance spherical surface 20 in the elected configuration to minimize coma and astigmatism, as mentioned earlier.

In one embodiment, the radius of curvature of the entrance optical surface 20 can determine the effective focal length of the imaging lens 10, and the radius of curvature of the exit optical surface 22 can be adapted to match the focal surface 12.

According to a first example pertaining to conventional approaches, an imaging lens can be embodied as a multi-element lens assembly wherein a train of spherical and/or aspherical lenses are properly located along a common optical axis and centered with precision about this same axis. In this case, an iris diaphragm can be inserted in the lens train and then properly located to act as the aperture stop of the lens train. Such a multi-element lens assembly may be suitable in some embodiments, but challenging in other embodiments. In particular, such a lens assembly may be complex to manufacture in regards of some factors such as the procurement of optical elements meeting the specified tolerance requirements, the tolerance stacking and its impact on the resulting assembly, and process steps pertaining to the alignment and positioning of each individual optical element mounted in the lens train.

In a second example, such a spherical lens design can be embodied with a monolithic (single-piece) body, where the shape of the monolithic body narrows down to a waist which acts, without the need of any additional component, as the aperture stop. Embodying a spherical lens design as a monolithic body rather than as a multi-element lens assembly can be advantageous in at least some embodiments or applications as it may, for instance, be easier to fabricate and/or represent productivity or quality gains in terms of assembly and/or alignment.

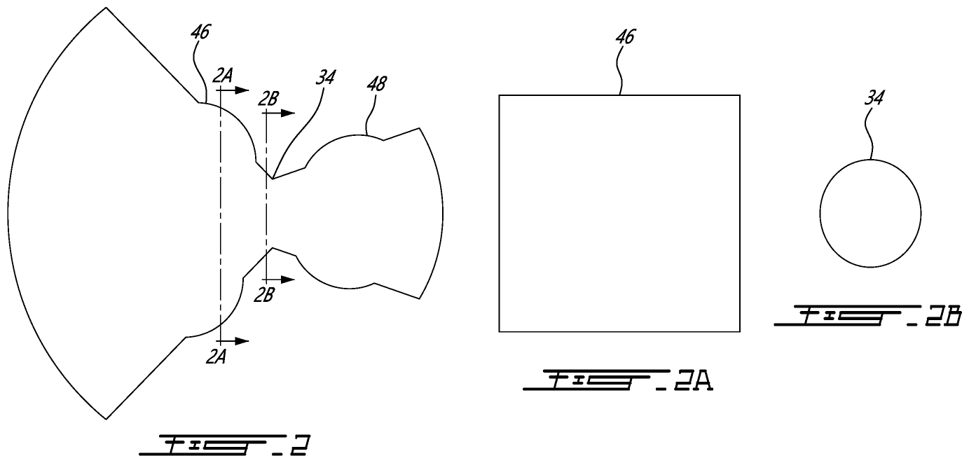

The simple double-truncated-cone shape for the lateral surface 24 of the imaging lens 10 as illustrated in FIG. 1 will be generally easier to manufacture than other shapes of potential use for the imaging lens 10. In some embodiments, the shape of the lateral surface 24 can differ from the one illustrated in FIG. 1. FIG. 2 presents an example embodiment of the imaging lens 10 where the shape of the monolithic body 16 departs from an otherwise perfect solid of revolution about the lens axis due to the presence of a number of local protrusions 46 and 48 at specific locations on the lateral surface 24. In this example, the aperture stop 34 has a circular contour, as shown in FIG. 2B. However, as illustrated in FIG. 2A, the protrusions 46, 48 are configured to provide two separate portions of the lateral surface 24 having square cross-sectional shapes. Such an example configuration may provide easier attachment of the imaging lens 10 to a holder or to various types of dedicated support structures.

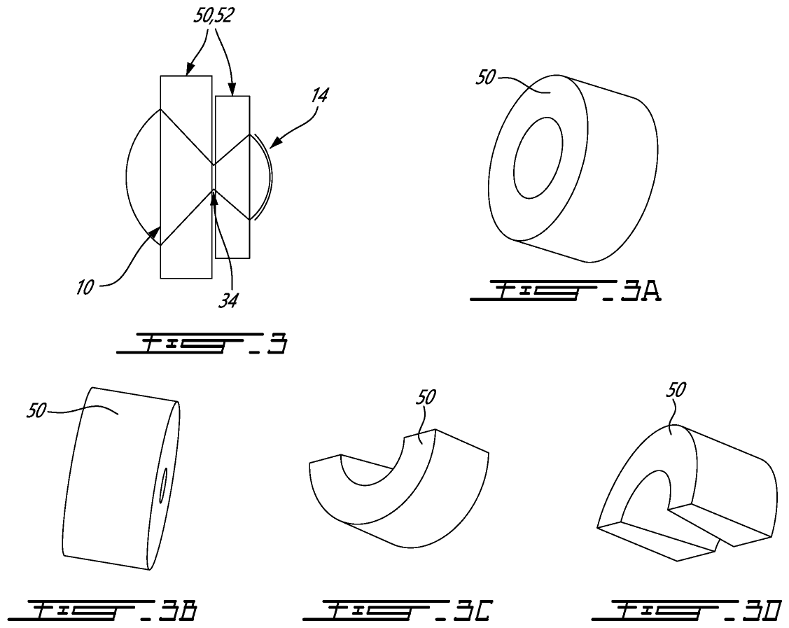

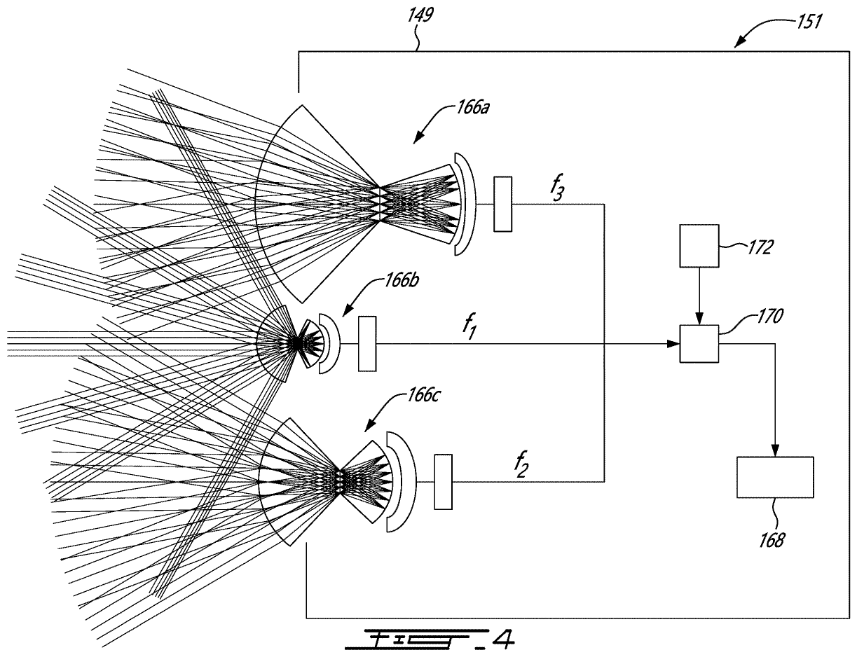

FIG. 3 presents a potential embodiment in which both truncated conical portions of the lateral surface 24 of the monolithic body 16 illustrated in FIG. 1 are encased in encasing structures 50, 52. FIGS. 3A and 3B present two different views of a first one of the encasing structures 50. In this embodiment, each one of the encasing structures 50, 52 can take the form of a cylinder in which is formed a center cavity having a truncated conical shape. As shown in FIGS. 3C and 3D, the encasing structure 50 can be made of two halves assembled around the entrance truncated conical portion 40 in the final assembly. The second encasing structure 52 can have similar features but adapted to the orientation and size of the exit truncated conical portion 42. The monolithic body 16 then remains distinct from the encasing structures 50, 52. In one potential embodiment, such encasing structures 50, 52 can be made of an optically-opaque material and be used for optical purposes such as impeding stray light. In another potential embodiment, the encasing structures 50, 52 can be used for mechanical purposes such as making the imaging lens 10 more robust, easier to handle and/or easier to attach to a support structure 49, 149 (see FIGS. 1 and 4). The encasing structures 50, 52 are optional and may be omitted in some embodiments. In the embodiment of FIG. 1, the imaging lens 10 can have a length of a few millimetre along the lens axis 18, such as between 5 and 50 mm, or between 10 and 25 mm. In some embodiments, the encasing structures can be shaped differently, such as in a manner to mate with female portions of a support structure 49, 149. In yet other embodiments, the encasing structures 50, 52 can be integrated into the monolithic body 16.

Turning now to the selection of image sensor arrays suitable for coupling to the imaging lens 10, it will be noted that the retina of the human eye is curved while the conventional image sensors that have been manufactured for many years are planar, namely in the form of two-dimensional (2D) arrays. An important challenge to which optical designers are frequently faced is to flatten the focal surface of the imaging lens (or lens assembly) to fit the planar shape of the commonly-encountered types of image sensor arrays, recalling that the focal surface of such imaging lenses is usually curved. This is an aberration called “field curvature,” which can be severe in some optical system designs, especially for optics designed to operate at low f-numbers. This type of optical aberrations can be corrected or compensated by adding lenses or optical correcting surfaces in the imaging lens train to ensure good image quality and satisfactory optical resolution, but this latter avenue often complicates the optical system design and its fabrication. In the last few years, an alternative approach to the use of planar image sensor arrays has received a lot of attention, this approach consisting in coupling an imaging lens 10 having a simpler design directly to a spherically-curved image sensor array (still referred herein to as FPAs, as noted earlier).

Example embodiments of spherically-curved image sensor arrays are described, for instance, in D. Dumas et al., “Curved focal plane detector array for wide field cameras”, Applied Optics, Vol. 51, pp. 5419-5424, (2012). These examples include image sensor arrays fabricated on curved substrates, image capture devices structured in small, interconnected image sensor arrays processed independently, and image sensor arrays having thinned substrates that can be curved by application of a suitable mechanical force.

Accordingly, for the image sensor array 14, a CMOS array, a CCD array, a cooled microbolometer FPA or an uncooled microbolometer FPA can be provided in spherically-curved form and used in combination with an imaging lens 10 having a curved focal surface 12. The image sensor array 14 is operable to generate electrical output signals indicative of a light irradiance distribution formed at the exit optical surface 22 of the imaging lens 10.

Returning back to FIG. 1, the camera 51 includes an electronic printed-circuit board (PCB) 36 that electrically connects to the image sensor array 14. The PCB 36 is operable to perform functions which may vary according to the type of image sensor array 14 mounted in the camera 51. For instance, the PCB 36 can control the operation of the array 14 through proper drive and timing electrical signals. Likewise, the PCB 36 can act as a read-out integrated circuit (ROIC) to electrically measure the signal outputted from each photosensitive element (pixel) of the image sensor array 14 after capture of a part of the light incident thereon and coming from the scene aimed by the camera 51. The PCB 36 can also perform other operations such as conditioning the output signals received from the array 14, converting those signals into the desired digital format and raw processing of the image data. The PCB 36 can then forward the image data to a computer 56 via any suitable data link 59. The computer 56 has a processor and a computer-readable memory accessible by the processor. The computer can have an image processor 58 configured, for instance, to receive and process the image data generated by the image sensor array 14. The image data may either be stored in memory 60, displayed on a display 62 forming part of a user interface 64, or both. The memory 60 can be a non-transitory memory which can further store instructions executable by a processor or additional, separate memory can be used to store instructions executable by the processor. The image data may be stored locally or externally/remotely, in which case it can be forwarded in a wired or wireless manner, such as over a network (e.g. a local network or a telecommunications network).

The computer 56 can have additional functions, integrated as software stored in non-transitory memory and accessible by a processor for instance. Such functionalities can include image processing functionalities which can be executed for example for f-theta distortion calibration, which can be particularly relevant in the case of wide FOV embodiments, to enhance the quality of the images at wide FOV. In the case of wide FOV infrared applications, the images can be processed with software packages to add color, if necessary, or to map into-grey shaded images to highlight specific targets and details present within the viewed thermal scene. In still another embodiment, an optical (phase) element can introduce a controlled amount of phase in the incoming wavefront to generate an intermediate image on the photosensitive area of the image sensor array 14, which can be optically coded, for a digital process based on a numerical deconvolution algorithm that reconstructs the final image for image sharpness processing and enhancement, if desired. Such a numerical deconvolution algorithm can be executed by the local computer 56, or by another computer to which data has been transferred, depending on the embodiment.

Considerable efforts have been devoted to imaging systems having a zoom capability enabled without moving parts. Some potential embodiments have disadvantages. For instance, some embodiments may require large and complicated optical macro elements to provide wide FOVs and low working f-number, these embodiments often revealing as bulky and heavy while being costly. Some embodiments provide a zoom feature that requires moving lens groups or mirror groups, and which possibly result in performance degradation due to the issues of precision maintenance of co-axial alignment along the lens axis during translation of the mobile optical parts. There can be a challenge in achieving a simple zoom optics while maintaining high resolution, wide field of view, low working f-number, and with no moving parts that can work with advanced optical sensors of next generation, and this challenge may be exacerbated in some embodiments intended for operation in IR spectral wavebands.

FIG. 4 presents an example embodiment of an imaging system 151 having a plurality of cameras 166a, 166b, 166c, each camera 166a, 166b, 166c having its dedicated imaging lens 10, image sensor array 14 and PCB 36 such as presented in FIG. 1. When being part of an imaging system 151, the cameras 166a, 166b, 166c can all be connected to a computer 170 (e.g. connected to computing resources such as processing units and memory). In this specific example, the cameras 166a, 166b, 166c have distinct fields of view owing to the different effective focal lengths f₁, f₂ and f₃ of the imaging lenses mounted in the cameras. Grouping the cameras 166a, 166b, 166c such as illustrated in FIG. 4 can lend itself to an imaging system 151 featuring a step-zoom function enabled by switching a display 168 to show the images generated from one camera to another based, for instance, on a user input received at a user interface 172. The cameras can be mounted in a common support structure 149 with a common boresight alignment wherein the lens axes of the different cameras 166a, 166b, 166c are parallel and spaced apart from one another. In some embodiments, it can be preferred to nest different cameras at different distances from a plane normal to the lens axes for the purpose of achieving a more compact arrangement than what could be achieved by locating, for example, the entrance vertices of the different cameras within a common plane normal to the lens axes. A device which can be referred to generally as a computer 170, which may include shared components or independent components in association with different ones of the cameras, can be used to receive the image data from all the different cameras 166a, 166b, 166c. This computer 170 can have a power supply and some form of user interface 172, which may include a display 168. The computer 170 can have software functionalities, such as a functionality to allow to switch the images on the display from one camera to another based on user inputs received at the user interface 172. In some embodiments, the group of cameras can be reconfigurable in the sense that one or more of the cameras can be received in sockets provided in the support structure 149, and be selectively removable from such socket(s) in a manner to allow their replacement with another camera having a different field of view. This feature then allows the user to change the zoom ratio of the whole imaging system 151, the zoom ratio being defined as the ratio between the maximum and minimum FOVs provided by the group of cameras. Alternate embodiments of the imaging system 151 can have different numbers of cameras, such as four or five, for example.

In an alternative embodiment, a stereoscopic (3D) imaging system 151 for operation in the infrared or visible spectral wavebands can be devised by creating pairs of cameras joined by a stereo baseline and having either the same or different effective focal lengths. In such an imaging system, each pair of cameras can be used to create a 3D reconstruction of the scene from a pair of 2D images associated to different vantage points, thus providing a sense of perspective. The stereo camera setup can involve two similar cameras separated from each other by a baseline distance T. The fields of view of the two cameras can overlap at a given distance in front of the stereo camera system, depending on the effective focal lengths of both cameras. The images generated by the pair of cameras can be used to calculate the depth-Z information in the viewed scene. The algorithm used to compute the depth information assumes that the distance between the two cameras and their relative orientation are constant and known.

The concepts presented above can be compatible to work with fast optics and wide FOVs, such as F/1 or faster, with an FOV of 120° or more, with good optical performance and a very simple, monolithic, imaging lens design.

The example embodiment presented in FIG. 4 can be adapted for operation in the MWIR waveband and provided with image sensor arrays in the form of spherically-curved microbolometer FPAs for the different cameras 166a, 166b, 166c. The embodiment can have a fast focal ratio of F/1.0 over a full field of view as large as from 120° down to 40° for a zoom ratio of 3.1× and with effective focal lengths (EFLs) of 3.26 mm, 6.52 mm, and 10.03 mm, respectively. Table 1 lists the values of the main optical design parameters for this embodiment.

TABLE 1
Exemplary optical design of a MWIR zoom-lens (3.1X) imaging system

| Effective focal length | f₁ = 3.26 mm | | f₂ = 6.52 mm | | f₃ = 10.03 mm | |
|---|---|---|---|---|---|---|
| Working F-number | F/1.0 | | F/1.0 | | F/1.0 | |
| Design waveband | 3-5 | μm | 3-5 | μm | 3-5 | μm |
| Full field of view | 120° | | 60° | | 40° | |
| Optical material | Gasir1 | | Gasir1 | | Gasir1 | |
| Entrance radius of | 5 | mm | 10 | mm | 15.38 | mm |
| curvature | | | | | | |
| Exit radius of | 3.25 | mm | 6.47 | mm | 9.94 | mm |
| curvature | | | | | | |
| Distance between | 8.23 | mm | 16.47 | mm | 25.32 | mm |
| entrance and exit | | | | | | |
| vertices | | | | | | |
| Focal surface radius | 3.25 | mm | 6.47 | mm | 9.94 | mm |

| | | | |
|---|---|---|---|
| of curvature | | | |
| MTF at sensor's | MTF > 62 at 35 | MTF > 58 at 35 | MTF > 55 at 35 |
| Nyquist cut-off | lp/mm | lp/mm | lp/mm |
| frequency | | | |

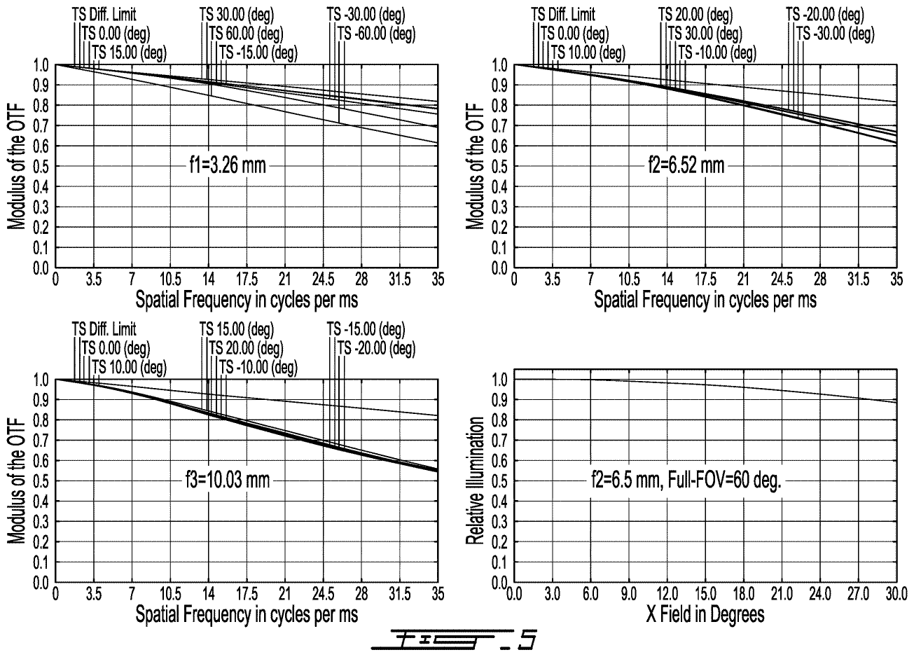

FIG. 5 shows the polychromatic MTFs (Modulation Transfer Functions) computed for each value of the effective focal lengths as listed in Table 1 above. In each panel, the MTF curves are displayed for some specific angular positions (TS) in the images. The computed polychromatic MTFs are very close to diffraction-limited performance across the full field of view. A computed curve of the relative illumination as a function of the angular position X for the zoom configuration with f₂=6.52 mm is also shown in the lower right panel of FIG. 5.

A fast focal ratio, such as F/1 or even faster, can be achieved for the design effective focal lengths of the cameras. The noise equivalent temperature difference (NETD) per pixel in the imaging system 151 can be fully equivalent to that of other IR imaging systems if the working f-number and pixel size are the same in both systems.

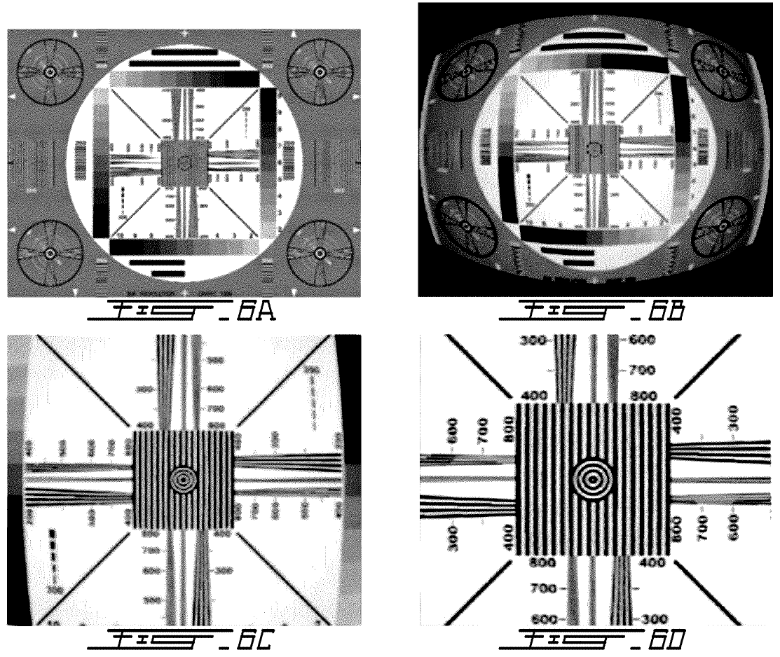

Zoom-image simulations have been carried out with the first example configuration having MWIR optics, as shown in FIG. 6 (Original input image, used for the simulations). The simulated spherically-curved image sensor array was an FPA of 375×310 pixels, 14 μm/pixel, with different radii of curvature such as R₁=3.25 mm, R₂=6.47 mm, and R₃=9.94 mm, respectively, for the three zoom configurations, and the fill factor of the FPA was assumed to be 100% in the simulations.

A second embodiment of an imaging system 151 can be devised for operation in the visible spectral waveband. This second embodiment can make use of a curved CMOS image sensor array 14. The configuration can provide moderate optical performance at proper working focal ratios over a full field of view as large as from 120° down to 34° for a zoom ratio of 4× and with effective focal lengths of 4.0 mm, 8.0 mm, and 16.0 mm, respectively. Table 2 lists the values of the main optical design parameters for this embodiment.

TABLE 2
Exemplary optical design of a zoom-lens (4X)
imaging system for visible wavelengths

| Effective focal length | f₁ = 4.0 mm | | f₂ = 8.0 mm | | f₃ = 16.0 mm | |
|---|---|---|---|---|---|---|
| Working F-number | F/2.47 | | F/4.0 | | F/6.0 | |
| Design waveband | 486-656 | nm | 486-656 | nm | 486-656 | nm |
| Full field of view | 120° | | 84° | | 34° | |
| Optical material | S-BSM16 glass | | S-BSM16 glass | | S-BSM16 glass | |
| Entrance radius of | 2.542 | mm | 5.022 | mm | 9.987 | mm |
| curvature | | | | | | |
| Exit radius of | 4.03 | mm | 8.04 | mm | 16.0 | mm |
| curvature | | | | | | |
| Distance between | 6.38 | mm | 12.87 | mm | 25.82 | mm |
| entrance and exit | | | | | | |
| vertices | | | | | | |
| Focal surface radius | 4.03 | mm | 8.04 | mm | 16.0 | mm |

| | | | |
|---|---|---|---|
| of curvature | | | |
| MTF at sensor's | MTF > 45 at 100 | MTF > 42 at 100 | MTF > 30 at 100 |
| Nyquist cut-off | lp/mm | lp/mm | lp/mm |
| frequency | | | |

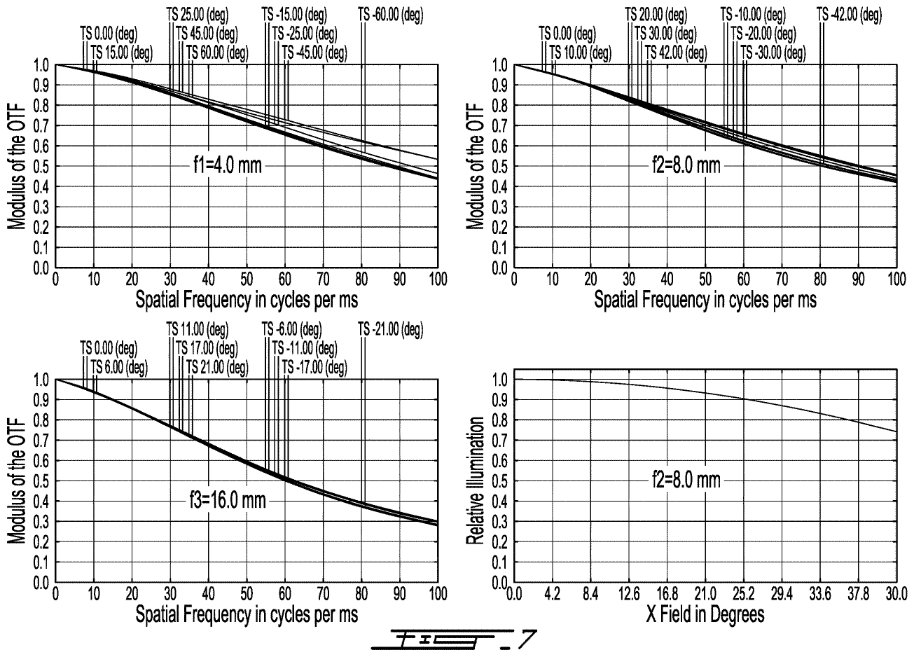

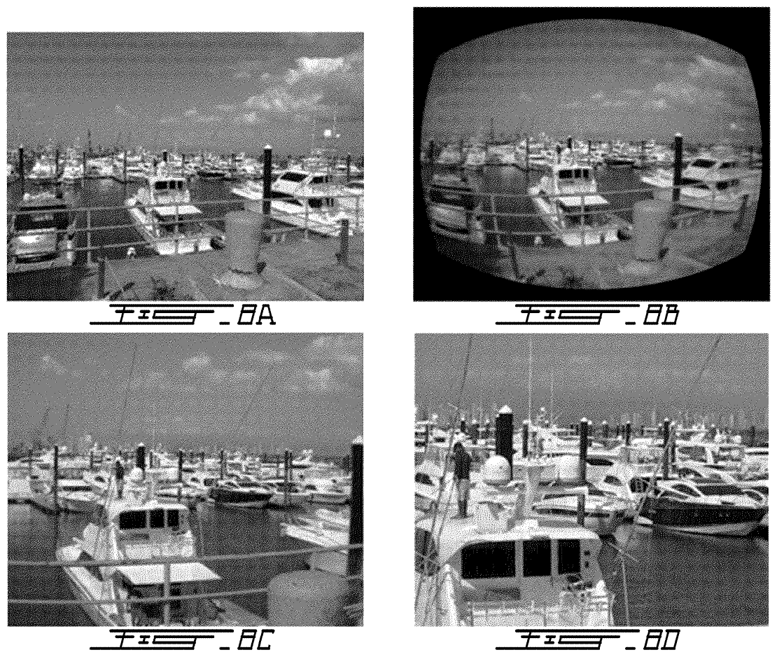

FIG. 7 shows the polychromatic MTFs computed for each value of the effective focal lengths as listed in Table 2 for this second embodiment. The computed polychromatic MTFs have a moderate performance across the full field of view. A computed curve of the relative illumination as a function of the angular position X for the zoom configuration with f₂=8.0 mm is also shown in the lower right panel of FIG. 7. Zoom-image simulations have been carried out with this second embodiment having optics suited for operation in the visible, as shown in FIG. 8 (Original input image, used for the simulations). The simulated spherically-curved image sensor array was an FPA of 1610×1328 pixels, 4 μm/pixel, with different radii of curvature 10 such as R₁=4.03 mm, R₂=8.04 mm, and R₃=16.0 mm, respectively, and the fill factor of the FPA was still assumed to be 100% in the simulations.

It will be understood that the expression “computer” as used herein is not to be interpreted in a limiting manner. It is rather used in a broad sense to generally refer to the combination of some form of one or more processing units and some form of memory system accessible by the processing unit(s). The memory system can be of the non-transitory type. The use of the expression “computer” in its singular form as used herein includes within its scope the combination of a two or more computers working collaboratively to perform a given function. Moreover, the expression “computer” as used herein includes within its scope the use of partial capabilities of a given processing unit. Example computers include desktop, laptop, smartphone, smart watch, less elaborated controller devices, etc.

A processing unit can be embodied in the form of a general-purpose micro-processor or microcontroller, an image processor, a digital signal processing (DSP) processor, an integrated circuit, a field programmable gate array (FPGA), a reconfigurable processor, a programmable read-only memory (PROM), to name a few examples.

The memory system can include a suitable combination of any suitable type of computer-readable memory located either internally, externally, and accessible by the processor in a wired or wireless manner, either directly or over a network such as the Internet. A computer-readable memory can be embodied in the form of random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), ferroelectric RAM (FRAM) to name a few examples.

A computer can have one or more input/output (I/O) interfaces to allow communication with a human user and/or with another computer via an associated input, output, or input/output device such as a keyboard, a mouse, a touchscreen, an antenna, a port, etc. Each I/O interface can enable the computer to communicate and/or exchange data with other components, to access and connect to network resources, to serve applications, and/or perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, Bluetooth, WiMAX), SS7 signaling network, fixed line, local area network, wide area network, to name a few examples.

It will be understood that a computer can perform functions or processes via hardware or a combination of both hardware and software. For example, hardware can include logic gates included as part of a silicon chip of a processor. Software (e.g. application, process) can be in the form of data such as computer-readable instructions stored in a non-transitory computer-readable memory accessible by one or more processing units. With respect to a computer or a processing unit, the expression “configured to” relates to the presence of hardware or a combination of hardware and software which is operable to perform the associated functions. Different elements of a computer, such as processor and/or memory, can be local, or in part or in whole remote and/or distributed and/or virtual.

As can be understood, the examples described above and illustrated are intended to be exemplary only. The scope is indicated by the appended claims.

What is claimed is:

1. An imaging lens, the imaging lens having a lens axis and comprising:
a monolithic body made of an optical material, the monolithic body having:
an entrance optical surface configured for receiving light incident thereon, the entrance optical surface being spherically curved with a convex curvature and an entrance center of curvature located on the lens axis;
an exit optical surface configured for direct coupling to a spherically-curved image sensor array, the exit optical surface being spherically curved with a convex curvature and an exit center of curvature located on the lens axis; and
a lateral surface extending from a periphery of the entrance optical surface to a periphery of the exit optical surface, the lateral surface being shaped such that the monolithic body has a minimum sectional diameter, the minimum sectional diameter and the entrance center of curvature being located in a same plane, the minimum sectional diameter defining an aperture stop centered on the lens axis and conjugate to an entrance pupil of the imaging lens;
wherein the imaging lens has a focal surface that is spherically curved with a focal curvature corresponding to the convex curvature of the exit optical surface, the focal surface being coincident with the exit optical surface.

2. The imaging lens of claim 1 wherein the lateral surface includes a first truncated conical portion extending between the minimum sectional diameter and the entrance optical surface, and a second truncated conical portion extending between the minimum sectional diameter and the exit optical surface, the first truncated conical portion joining the second truncated conical portion in the plane of the minimum sectional diameter.

3. The imaging lens of claim 1 further comprising a coating of optically opaque material covering the lateral surface.

4. The imaging lens of claim 1 wherein the lateral surface is a surface of revolution about the lens axis.

5. The imaging lens of claim 1 wherein the monolithic body has a cross-sectional area continuously decreasing from the entrance optical surface to the plane of the minimum sectional diameter.

6. The imaging lens of claim 5 wherein the cross-sectional area of the monolithic body continuously decreases from the exit optical surface to the plane of the minimum sectional diameter.

7. The imaging lens of claim 1 wherein the optical material is one of germanium, zinc selenide, and molded chalcogenide glass.

8. The imaging lens of claim 1 wherein the optical material is one of optical glass and an optical polymer.

9. The imaging lens of claim 1 wherein antireflective coatings are provided on the entrance optical surface and the exit optical surface.

10. A camera comprising:
the imaging lens of claim 1;
the image sensor array being spherically curved and having a two-dimensional array of photosensitive elements, said image sensor array having a sensor curvature adapted for direct optical coupling to the exit optical surface, said image sensor array being operable to generate electrical output signals indicative of a light irradiance distribution formed at the exit optical surface; and
an electronic printed-circuit board operable to control the image sensor array and to generate output image data.

11. An imaging system comprising:
a plurality of cameras as defined in claim 10,
a support structure receiving each camera of the plurality of cameras, the plurality of cameras having a common boresight alignment with the lens axes of the imaging lenses of the plurality of cameras being parallel and spaced apart from one another;
a display screen;
a user interface; and
an image processor operable to receive and process the image data from the plurality of cameras and to display images on the display screen.

12. The imaging system of claim 11 wherein each camera of the plurality of cameras has a different field of view.

13. The imaging system of claim 12 enabling a step-zoom feature wherein the image processor is operable to switch the image displayed on the display screen from one of the cameras to another one of the cameras based on a user input received from the user interface.

14. The imaging system of claim 11 wherein the image processor is operable to generate a 3D image based on the image signals simultaneously received from at least two of the cameras.

15. The imaging system of claim 11 wherein the support structure has a plurality of sockets receiving corresponding cameras of the plurality of cameras, at least one of the cameras being removable from the corresponding socket and replaceable by an alternative camera having a different field of view.
